(19) United States
(12) Patent Application Publication
(10) Pub. No.: US 2004/0267581 A1
(43) Pub. Date: Dec. 30, 2004

(54) System, method, and computer program product for employee migration assessment and forecast

(75) Inventors: Uma M. Krishnamurthy, Chennai (IN); Pushpa Neelakantan, Chennai (IN); Radhika R. Gannamani, Tanuku (IN); David Peterson, Springboro, OH (US); Ronald Frederick, Beavercreek, OH (US)

Correspondence Address: DOCKET CLERK, DM/EDS, P.O. DRAWER 800889, DALLAS, TX, 75380, US

(73) Assignee: ELECTRONIC DATA SYSTEMS CORPORATION, Plano, TX

(21) Appl. No.: 10/603,061

(22) Filed: Jun. 24, 2003

(51) Int. Cl. G06F 17/60

(52) U.S. Cl. 705/7

(57) ABSTRACT

A system, process and computer program product that incorporates critical determining factors and outputs a model for an efficient and cost-effective migration. The disclosed system accepts as input critical data as defined in an RFI, RFP, and application inventories, applies weighting factors, and produces a high-level plan for an efficient and cost-effective migration.

### TECHNICAL FIELD OF THE INVENTION

The present invention is directed, in general, to a system and method for managing business-function employee migration.

### BACKGROUND OF THE INVENTION

Many times, and particularly when the economy is performing poorly, cost-cutting measures are an important part of any company's business management strategy. Based on minimal information available, these companies must predict the optimal percentage of work to be migrated (moved offshore or to some other geographic location) and the timelines to achieve the migration. For service companies, it is very common to be required to respond to a prospective client through the Request for Proposal (RFP) with an offshore engagement model that includes the offshore/onsite ratio and timelines to achieve the migrations.

To do so, the company must rely on the minimal information that has been gathered through the RFI (Request for Information) and RFP stages. The optimal model for offshore/onsite would be one that provides maximal cost savings at minimal risk of delivery. To arrive at this model, it is important that crucial determining factors are considered. Currently, there is no standard means for defining or quantifying such a model.

There is, therefore, a need in the art for a system, process and computer program product that incorporates critical determining factors and outputs a model for an efficient and cost-effective migration.

### SUMMARY OF THE INVENTION

The preferred embodiment provides a system, process and computer program product that incorporates critical determining factors and outputs a model for an efficient and cost-effective migration. The disclosed system accepts as input critical data as defined in an RFI, RFP, and application inventories, applies weighting factors, and produces a high-level plan for an efficient and cost-effective migration.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith, ” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a flowchart of a process in accordance with a preferred embodiment;

FIG. 2 depicts a block diagram of a data processing system in which an embodiment of the present invention can be implemented; and

FIG. 3 depicts a very high-level block diagram of an embodiment of the present invention.

### DETAILED DESCRIPTION OF THE INVENTION

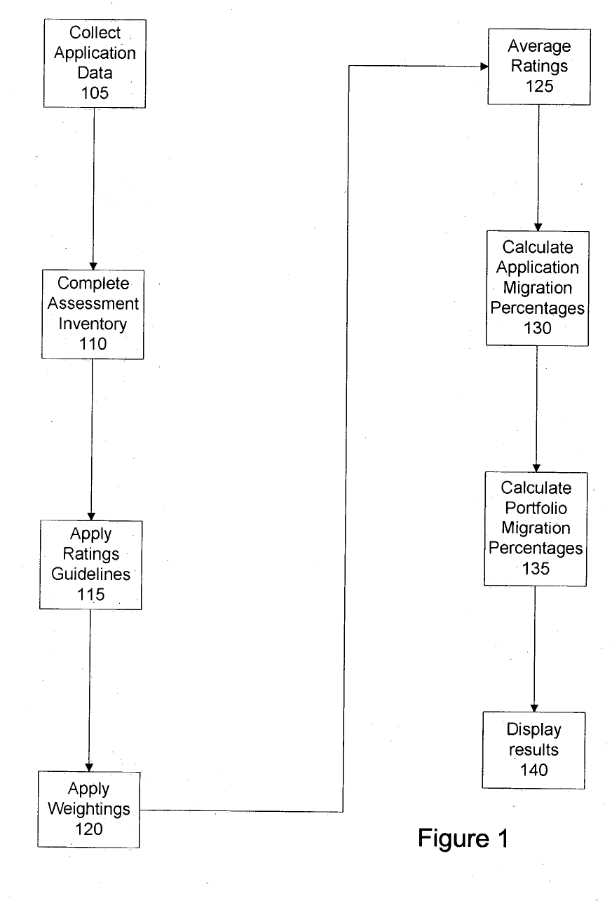

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

The preferred embodiment provides a system, process and computer program product that incorporates critical determining factors and outputs a model for an efficient and cost-effective migration. The disclosed system accepts as input critical data as defined in an RFI, RFP, and application inventories, applies weighting factors, and produces a high-level plan for an efficient and cost-effective migration.

Glossary

Assessment Factor—Factors that influence in determining the migration feasibility. Each Assessment factor is a combination of distinct datapoints (or Fields) collected through Application Inventory. In the preferred embodiment, 4 Assessment Factors are defined—Client Interface, Technology, Application Management, Application Category. For each application, depending on the values given in Application Inventory, the Sales or Assessment team would rate each of the 4 Assessment Factors

Rating Guidelines Table—Matrix given in the Ratings sheet described below, that gives guidelines for rating each of the Assessment Factors, based on the data points given in the Assessment Inventory sheet.

Rating Value—Values ranging from 1 to 5, 5 being very conducive for migration. Rating Value=Truncated Average of the Assessment Factor values

Ratings-Migration Percentage Table—Matrix that gives Potential Offshore % for Year 1, Year 2 and Year 3 for Rating values between 1 through 5.

There are many factors that influence decisions made on onsite—offshore ratios, some of them being client proximity, technology areas, system complexity etc. The system of the preferred embodiment involves a mechanism of identifying key factors that largely influence the onsite—offshore ratio and assigning of appropriate ratings to each. These factors are not all inclusive, but key to determine the offshore ratio.

A matrix of ratings against factors has been developed and is used to determine a three-year plan. The user will analyze the information it has received from the RFI/RFP/Inventory and provide inputs to the system of the preferred embodiment, which will then generate a migration plan. The resulting plan includes a resource outlook over a period of 3 years for each of the applications within the client's portfolio.

In the presently preferred embodiment, a spreadsheet is used as the input interface, wherein the disclosed processing is performed and the recommended migration plan is displayed therein.

The input to the disclosed system includes the following, described more fully below:

Information from Request for Information (RFI);

Information from Request for Proposal (RFP);

Application Inventory Information; and

Application Inventory Spreadsheet.

These data are entered into the Assessment Inventory Spreadsheet as described below. The system will then analyze the information in the Assessment Inventory Spreadsheet.

The Rating Guidelines Table provides a matrix of Critical factors affecting migration of work based on the data points in the Assessment Inventory Spreadsheet. In most occasions, this will provide all the data that is required for you to use the rating guidelines table.

Once all the required data is input, and any described function tailoring is done, the summary sheet will provide high-level Year 1, Year 2 and Year 3 migration percentages.

Tailoring Guidelines

The system of the preferred embodiment uses the information from the Application Inventory Spreadsheet. The rating guidelines specify that if the team size is less than 4, the probability of successful migration is very less. Alternatively, if the portfolio has many small sized teams, then it may be worthwhile to look at it from a different perspective rather than at an application level. Applications with similar technology or functional area may be grouped to form a larger team for migrating offshore.

Similarly, there may be many applications requiring specialized skills such as SAP, Database administration etc. It may help to group them logically rather than as individual applications.

The engagement model output from the System of the preferred embodiment provides a three year break-up of potential migration percentage per Application and for the entire portfolio.

Procedure

1. Collect the application inventory information and place it into the Application Inventory spreadsheet.

The application inventory spreadsheet includes columns for entry, as pertains to each application, of Business Unit, Client Application Leader (last name, first name, phone), Application Name, Application Acronym, System Description, Potential Growth, “Remaining Life (Years)”, Application Type, Application Complexity, System Stability, Application Criticality, Time Criticality, Documentation Status, Batch or Online, Application Availability Timings, Application Support Timings, Application Support Location, Original Production Date, Contractors Full-time Equivalent employees (FTE), the number of FTE providing high-level project Support, the number of FTE Supporting Enhancement, the number of FTE Supporting Break/Fix Only, Total FTE, Technology Platform, System Architecture, Technical Skills, DBMS Tools/Third Party Software, and details of the remote support location(s).

The user should ensure that the Total FTE figures are correct for all entries in Application Inventory.

The last row should reflect the totals, across all applications, for FTE. The assessment factors include the Client Interface, Technology, Application Management, Application Category, and Application Life. The Impact values include Client Interface Impact, Technology Impact, Application Management Impact, and Application Category Impact.

For each application entry in the inventory, the user will score the four assessment factors above in corresponding columns in Application Inventory Sheet as described. If the application Life is longer than 12 months, score Application Life as “1”; otherwise, score is at “0”.

The offshore FTE, at Application Portfolio level, is determined by the weighted averages, by the total FTE, of the Client Interface factor, the Technology factor, the Application management factor, and the Application Category factor.

Rating guidelines for each assessment factor, in the preferred embodiment, are described below.

For the Client Interface assessment factor, reference data points include the number of FTE providing high-level project support, the number FTE supporting enhancement, the number of FTE supporting break/fix only, and total FTE. A “5” rating value is applied if 0-30% FTE are required at onsite, a “4” rating value is applied if 31-50% FTE are required at onsite, a “3” rating value is applied if 51-60% FTE are required at onsite, a “2” rating value is applied if 61-75% FTE required at onsite, and a “1” rating value is applied if 76-100% FTE required at onsite.

For the technology assessment factor, reference data points include technology platform, system architecture, technical skills, DBMS, tools/third party software, FTE supporting enhancement, and total FTE. A “5” rating value is applied if the technology includes. mainframe/midrange technology or data engineering work. A “4” rating value is applied if the technology includes stand-alone/few-interfaces which were developed in-house. A “3” rating value is applied if the technology includes at least 50% FTE client/server technology enhancements, Or is not more than 25% FTE mainframe/midrange and at least 75% FTE client/server or web. A “2” rating value is applied if the technology includes client/server technology and less than 50% FTE on enhancements. A “1” rating value is applied if the technology requires specialized hardware, software, or network technology that cannot be supported from the remote site, predominantly local-area technology, or if the entire team supports client/server technology with real-time support and a high bandwidth requirement.

For the application management assessment factor, reference data points include stability, documentation status, complexity, and application type. A “5” rating value is applied if the technology is stand-alone, with few-interfaces, was developed in-house, and is of low complexity, or is stable, has adequate documentation, and is of medium complexity. A “4” rating value is applied if the technology is stand-alone, with few-interfaces, is developed in-house, is stable, has moderately adequate documentation, and is of medium complexity. A “3” rating value is applied if the technology is a customized package, with multiple interfaces, is stable, has insufficient documentation, and is medium complex, or if it is stable, with adequate documentation, and is highly complex. A “2” rating value is applied if the technology is a customized package, has multiple interfaces, is stable, has moderately adequate documentation, and highly complex, or if it is moderately stable and of medium complexity. A “1” rating value is applied if the technology is highly complex, and has insufficient documentation, or if it is highly unstable but of medium complexity and has insufficient documentation, or if it is unstable and highly complex.

For the application category factor, reference data points include application category criticality, the number of FTE supporting enhancement tools or a third party software team, the size, and potential growth. A “5” rating value is applied if the application is less critical or is moderately critical and has more than 70% FTE enhancements. A “4” rating value is applied if the application is moderately critical and has less than 70% FTE effort in ongoing enhancements, or is critical, disaster recovery takes more than 48 hours, has more than 50% FTE effort in enhancements, and the team size is at least eight. A “3” rating value is applied if the application is critical, disaster recovery takes more than 48 hours, there is less than 50% effort in enhancements, the team size is at least eight, and it is a product-based application with high growth expected. A “2” rating value is applied if the application is critical, disaster recovery takes more than 48 hours, there is less than 50% effort in enhancements, team size is less than eight, and the application is a customized 3rd party product with moderate growth expected, or if the application is critical, disaster recovery takes less than 48 hrs, less than 50% FTE effort in enhancements, the team size is greater than eight, and the application is a customized 3rd party product with moderate growth expected. A “1” rating value is applied if the application is critical, disaster recovery takes less than 48 hrs, there is less than 50% FTE effort in enhancements, the team size is less than eight, and if the application is a customized 3rd party product with no anticipated growth that is expected to retire in the next 1-2 years.

Once all rating factors have been applied, the rating factors are averaged.

Output

The preferred embodiment provides the percentage of total FTE that can be migrated offshore in Year1, Year2 and Year3 respectively. The following logic is built into the formula given in these columns.

```
    if application life is <= 1, % Offshore FTE = 0.
    Else
    if any of the assessment factors are rated as 1, then
% Offshore FTE = 0;
    else
    {
    Rating Value = Truncated (average of the Assessment
Factors ratings )
    Offshore % = Percentage corresponding to the Rating
Value (given in Rating − Migration Percentage table of
the Ratings sheet).
    e.g., If Rating value is 3, Offshore % for Year 1,2
and 3 are 10%, 30% and 50% respectively.
        }
```

The Rating-Migration table, according to the preferred embodiment, is:

| | % Offshore - | % Offshore - | % Offshore - |
|---|---|---|---|
| Rating value | Year 1 | Year 2 | Year 3 |
| 5 | 40% | 50% | 70% |
| 4 | 30% | 50% | 50% |
| 3 | 10% | 30% | 50% |
| 2 | 10% | 20% | 20% |
| 1 | 0% | 0% | 0% |

The Offshore FTE for each application are calculated by multiplying Total FTE with the Offshore % values shown in the table above according to the average rating value. As is seen, applications with a term of less than one year, or with any rating factor of “1,” should not be migrated.

The Offshore FTE at Portfolio level is calculated in by multiplying the portfolio level percentages above by the total FTE.

The system of the preferred embodiment provides a comprehensive coverage of all critical factors that influence migration and addresses the technical feasibility of migrating work offshore. There could be factors in addition to those identified that may influence the offshore ratios. In addition, the preferred embodiment assumes that all factors have equal weight; in other embodiments, each factor is weighted as necessary.

FIG. 1 depicts a flowchart of a process in accordance with the preferred embodiment. First, application data is collected from the RFP, RFI, and other sources (step 105), and entered into the assessment inventory (step 110). Next, the rating guidelines are applied, and entered into the system (step 115).

Weightings, if any, are applied (step 120). The weighted ratings are then averaged, and the average is truncated to the whole number (step 125).

The application migration percentages are calculated from the weighted rating average (step 130). Finally, the portfolio migration percentages are calculated (step 135), and the results are displayed (step 140).

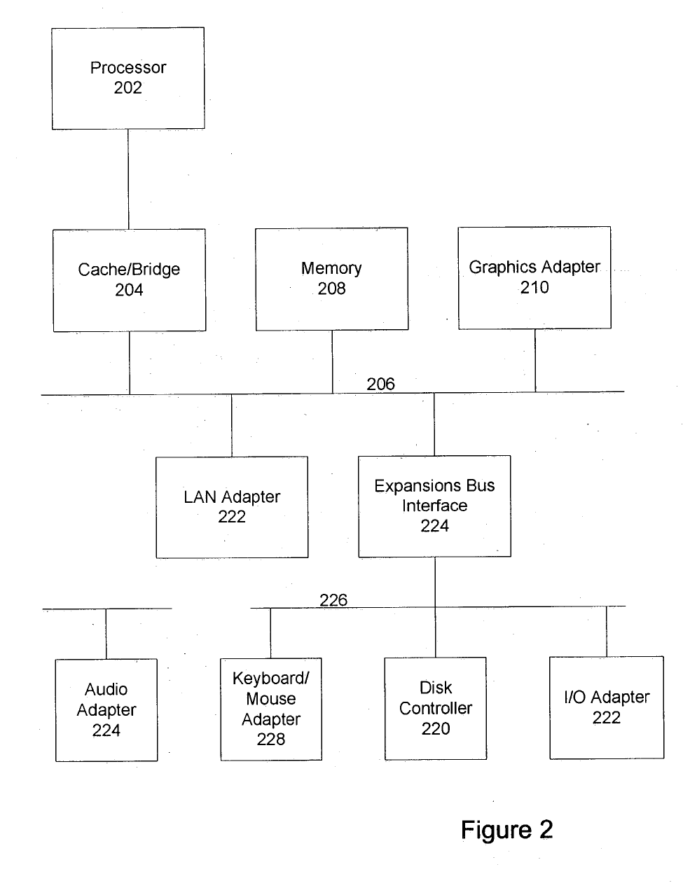

FIG. 2 depicts a data processing system in which a preferred embodiment of the present invention may be implemented. The data processing system depicted includes a processor 202 connected to a level two cache/bridge 204, which is connected in turn to a local system bus 206. Local system bus 206 may be, for example, a peripheral component interconnect (PCI) architecture bus. Also connected to local system bus in the depicted example are a main memory 208 and a graphics adapter 210.

Other peripherals, such as local area network (LAN) adapter 212, may also be connected to local system bus 206. Expansion bus interface 214 connects local system bus 206 to input/output (I/O) bus 216. I/O bus 216 is connected to keyboard/mouse adapter 218, disk controller 220, and I/O adapter 222. Also connected to I/O bus 216 in the example shown is audio adapter 224, to which speakers (not shown) may be connected for playing sounds. Keyboard/mouse adapter 218 provides a connection for a pointing device (not shown), such as a mouse, trackball, trackpointer, etc.

Those of ordinary skill in the art will appreciate that the hardware depicted in FIG. 2 may vary for particular. For example, other peripheral devices, such as an optical disk drive and the like, also may be used in addition or in place of the hardware depicted. The depicted example is provided for the purpose of explanation only and is not meant to imply architectural limitations with respect to the present invention.

A data processing system in accordance with a preferred embodiment of the present invention includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present invention as described. Further, a spreadsheet application such as Microsoft Excel™ can be used to implement certain aspects of the present invention.

Those skilled in the art will recognize that, for simplicity and clarity, the full structure and operation of all data processing systems suitable for use with the present invention is not being depicted or described herein. Instead, only so much of a data processing system as is unique to the present invention or necessary for an understanding of the present invention is depicted and described. The remainder of the construction and operation of data processing system 200 may conform to any of the various current implementations and practices known in the art.

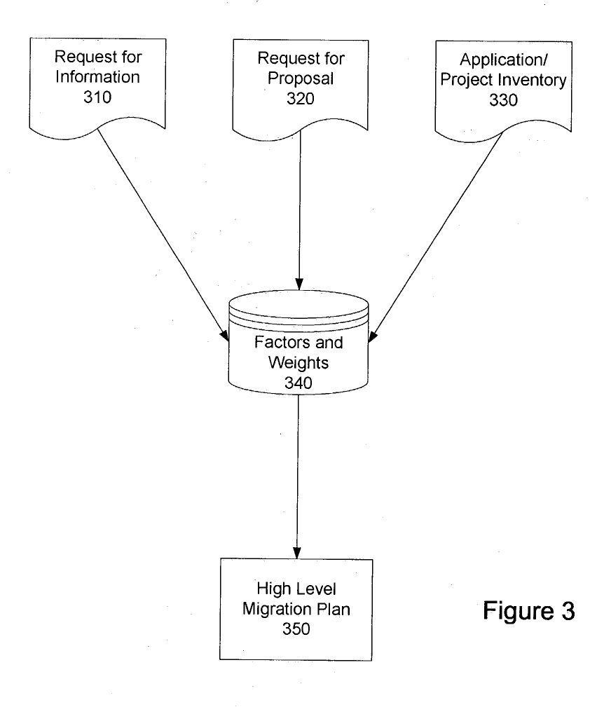

FIG. 3 depicts a very high-level view of one embodiment of the present invention. Here, information from the request for information 310, the request for proposal 320, and the application/project inventory 330 are input to system 340. In system 340, the various assessment factors, ratings, and weights are applied as described above, and the high-level migration plan 350 is output.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

What is claimed is:

1. A method for computer application migration planning, comprising:
collecting application data;
assigning ratings according to a plurality of assessment factors;
averaging the ratings to determine an average rating; and
determining employee migration percentages according to the average rating.

2. The method of claim 1, wherein the assessment factors include at least one factor selected from the group consisting of client interface, technology, application management, and application category.

3. The method of claim 1, further comprising applying weightings to the ratings.

4. The method of claim 1, further comprising determining employee migration figures by multiplying the employee migration percentages by the number of full-time equivalent employees.

5. The method of claim 1, wherein the assessment factors include at least one factor selected from the group consisting of client interface, technology, application management, and application category.

6. A data processing system, comprising:
means for receiving application data;
means for receiving ratings corresponding to a plurality of assessment factors;
means for averaging the ratings to determine an average rating; and
means for determining employee migration percentages according to the average rating.

7. The data processing system of claim 6, wherein the assessment factors include at least one factor selected from the group consisting of client interface, technology, application management, and application category.

8. The data processing system of claim 6, further comprising means for applying weightings to the ratings.

9. The data processing system of claim 6, further comprising means for determining employee migration figures by multiplying the employee migration percentages by the number of full-time equivalent employees.

10. The data processing system of claim 6, wherein the assessment factors include at least one factor selected from the group consisting of client interface, technology, application management, and application category.

11. A computer program product tangibly embodied in a computer-readable medium, comprising:
instructions for receiving application data;
instructions for receiving ratings corresponding to a plurality of assessment factors;
instructions for averaging the ratings to determine an average rating; and
instructions for determining employee migration percentages according to the average rating.

12. The computer program product of claim 11, wherein the assessment factors include at least one factor selected from the group consisting of client interface, technology, application management, and application category.

13. The computer program product of claim 11, further comprising instructions for applying weightings to the ratings.

14. The computer program product of claim 11, further comprising instructions for determining employee migration figures by multiplying the employee migration percentages by the number of full-time equivalent employees.

15. The computer program product of claim 11, wherein the assessment factors include at least one factor selected from the group consisting of client interface, technology, application management, and application category.
